(19) United States
(12) Patent Application Publication
(10) Pub. No.: US 2026/0096948 A1
(43) Pub. Date: Apr. 9, 2026

(54) LIFE WAVES AND USES THEREOF

(71) Applicant: Xunhua ZHANG, New York, NY (US)

(72) Inventor: Xunhua ZHANG, New York, NY (US)

(21) Appl. No.: 19/067,880

(22) Filed: Mar. 1, 2025

Related U.S. Application Data
(60) Provisional application No. 63/560,482, filed on Mar. 1, 2024.

(51) Int. Cl. A61H 39/00; A61H 23/02

(52) U.S. Cl. CPC A61H 39/007; A61H 23/0236; A61H 2201/0134; A61H 2201/0146; A61H 2201/165; A61H 2201/5025

(57) ABSTRACT

This disclosure is about a method for moderating physiological bodily conditions of a subject comprising administering an appropriate amount of appropriate wave for an appropriate duration to the said subject thereby modulating the physiological conditions of the said subject. A device for moderating function in a subject capable of generating or transmitting appropriate life wave to moderate said function in said subject is also disclosed. The duration and intensity of the waves can be adjusted depending on different physiological conditions. A method for moderating functions in a subject using life waves comprising steps of selecting a wave of appropriate wavelength; selecting an appropriate amplitude; and choosing optimal duration so that the chosen life wave can affect and then moderate the said function is also disclosed.

### REFERENCE TO RELATED APPLICATIONS

This application claims the priority of U.S. provisional application No. 63/560,482, filed Mar. 1, 2024. The entire contents and disclosure of the proceeding applications are incorporated by reference into this application.

Throughout this application, various publications are cited. The disclosure of these publications in their entireties is hereby incorporated by reference into this application to more fully describe the state of the art to which this invention pertains.

### BACKGROUND OF THE INVENTION

The fundamental cause of human aging lies in the degradation of cell function and decline in metabolic capacity. In recent years, life wave technology, as a brand-new bioinformation intervention method, has demonstrated potential cell-level anti-aging capabilities. Eternal Cell technology is based on the principle of life waves and combines super-energy active water with brain conduction equipment to help update brain cell memory, thereby achieving the effect of “reverse age growth”. This article discusses the scientific principles and feasibility of life wave technology in the field of anti-aging.

Life wave is a biological electromagnetic vibration wave of specific frequency and energy, which is closely related to cell membrane potential, nerve electrical signals and biological resonance phenomena. Research shows that cells transmit information through bioelectrical signals, and specific resonance frequencies can regulate the metabolic activity of cells, repair DNA damage, and optimize mitochondrial function.

Studies have found that the mitochondrial activity of aging cells decreases, resulting in a decrease in the synthesis of ATP (cellular energy currency). Life waves can stimulate the electrochemical gradient in cells, promote mitochondrial ATP synthesis, and increase cell energy levels. Scientific studies have shown that telomere shortening is a key factor in aging. Life wave resonance can activate telomerase, extend telomere length, promote DNA repair, and improve gene stability. Life wave brain conduction equipment can use specific wave frequencies that resonate with brain cells to optimize neuronal signal transmission. Studies have shown that the synaptic plasticity of neurons is affected by bioelectric fields. Appropriate electromagnetic signals can activate neural networks, improve cognitive functions, and slow down neurodegenerative diseases caused by aging. Life waves are combined with super-energy active water to improve the permeability of cell membranes, accelerate the removal of cell waste, optimize the intracellular environment, and enhance metabolic efficiency. Scientific research shows that changes in the physical structure of water molecule clusters can increase water absorption rate and improve cell hydration.

Research from Harvard University and MIT shows that electromagnetic signals of a specific frequency can promote stem cell differentiation and accelerate tissue repair. Experiments at Stanford University show that low-intensity electromagnetic field stimulation can delay cognitive decline in Alzheimer's patients. A study in Nature magazine in 2015 showed that telomerase activation can reverse the aging process and restore physiological functions in mouse experiments. The frequency regulation mechanism of life waves helps activate telomerase, thereby delaying aging. Experiments at the University of Tokyo in Japan show that changes in the physical structure of water molecules affect the opening of cell membrane ion channels, thereby optimizing cell signal transduction. Super-energy active water under the action of life waves can enhance the solubility and bioavailability of water and improve cell metabolism.

Combined with existing biophysics, neuroscience and molecular biology research, Life Wave technology has the potential to promote cell activation, repair DNA, optimize nervous system function and improve cell hydration. Eternal Cell technology uses Life Wave's brain conduction equipment and super-energy active water to provide continuous energy support for cells and promote brain memory renewal, thereby achieving “anti-aging growth”. In the future, further clinical research and experimental verification will help reveal its wider application potential and provide scientific support for human health and longevity.

### SUMMARY OF THE INVENTION

This disclosure is about a method for moderating physiological bodily conditions of a subject comprising administering an appropriate amount of appropriate wave for an appropriate duration to the said subject thereby modulating the physiological conditions of the said subject. A device for moderating function in a subject capable of generating or transmitting appropriate life wave to moderate said function in said subject is also disclosed. The duration and intensity of the waves can be adjusted depending on different physiological conditions. A method for moderating functions in a subject using life waves comprising steps of selecting a wave of appropriate wavelength; selecting an appropriate amplitude; and choosing optimal duration so that the chosen life wave can affect and then moderate the said function is also disclosed.

### FIELD OF THE INVENTION

The present invention relates to a life wave for therapy utilizing energy waves, e.g., sound waves, and also relates to method of using the device.

### BRIEF DESCRIPTION OF THE FIGURES

FIG. 1 is a top view of one embodiment of the device used in the method.

FIG. 2 is a top view of one embodiment of the device used in the method, two of which are placed side by side and can be used simultaneously.

FIG. 3 is a drawing showing a speaker 1 embedded in a device enabling a user to control the device, adjusting the duration and intensity of the wave.

FIG. 4 is a drawing showing the side view of a speaker 1 embedded in a device enabling a user to control the device, adjusting the duration and intensity of the wave.

FIG. 5 is a drawing showing a detailed structure of a speaker 1 in an embodiment of the device.

FIG. 6 is a drawing showing the top and side view as well as a detailed structure of a speaker 2 in an embodiment of the device.

FIG. 7 is a drawing showing one embodiment of the device in the form of a bed wherein multiple wave generators were embedded.

FIG. 8 describes how life waves can be administered to the body using a acupuncture device.

FIG. 9 shows multiple embodiments of the device in the form of wearable speakers, speakers on a tripod, headsets, cushions, and acupuncture devices.

FIG. 10 show an embodiment in the form of a headset wearable on the lower body.

FIG. 11 shows an embodiment in the form of a mattress.

FIG. 12 shows an embodiment in the form of a helmet.

FIG. 13 shows an embodiment in the form of a pillow.

FIG. 14 shows an embodiment in the form of a sphere that can be placed in the pelvic area.

FIGS. 15 (15-1, 15-2, 15-3, and 15-4) shows an embodiment in the form of a capsule.

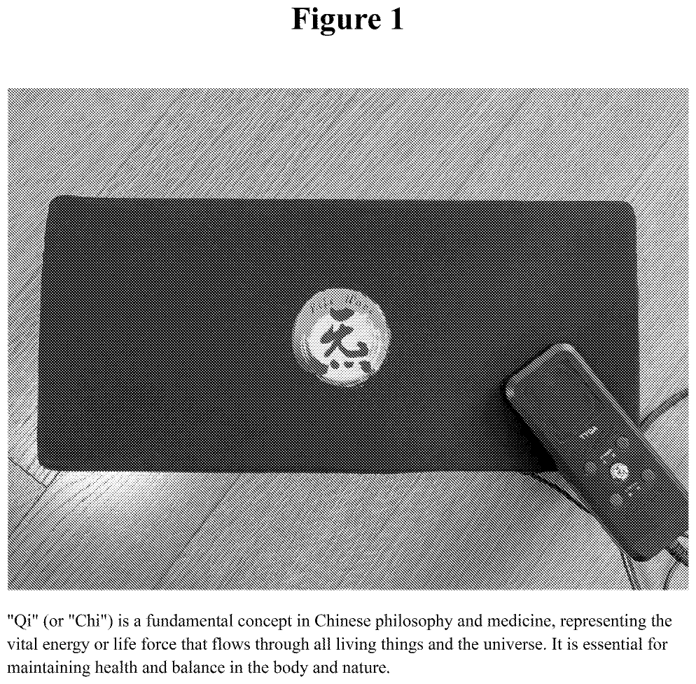

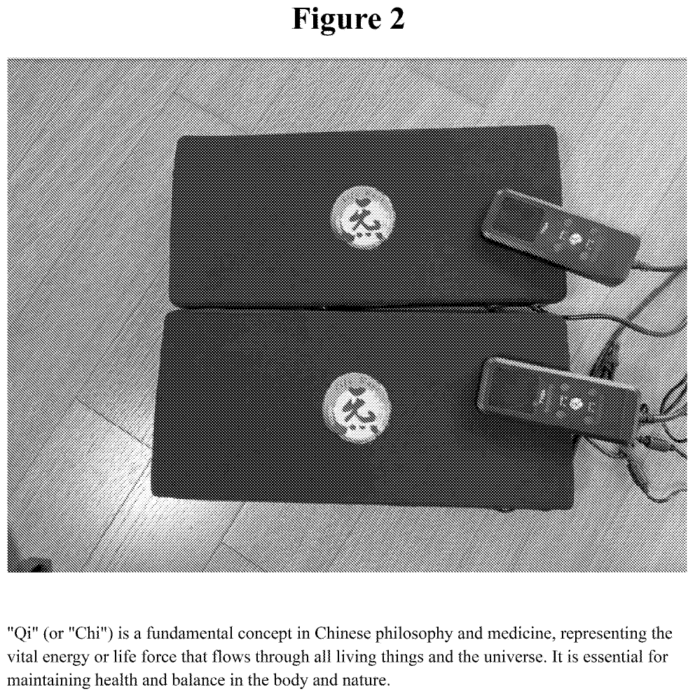

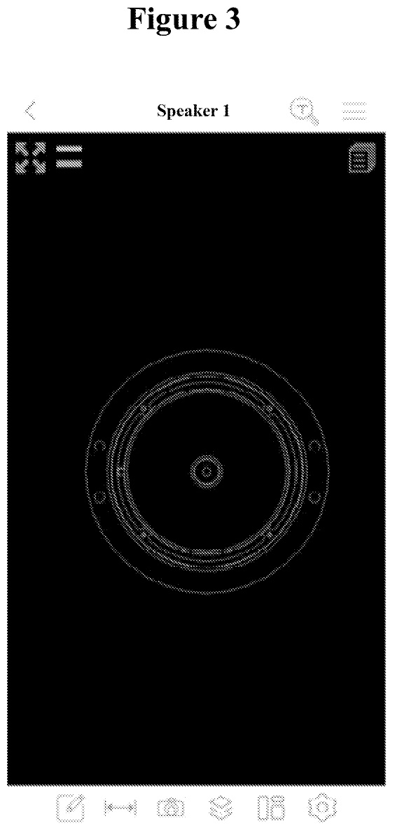

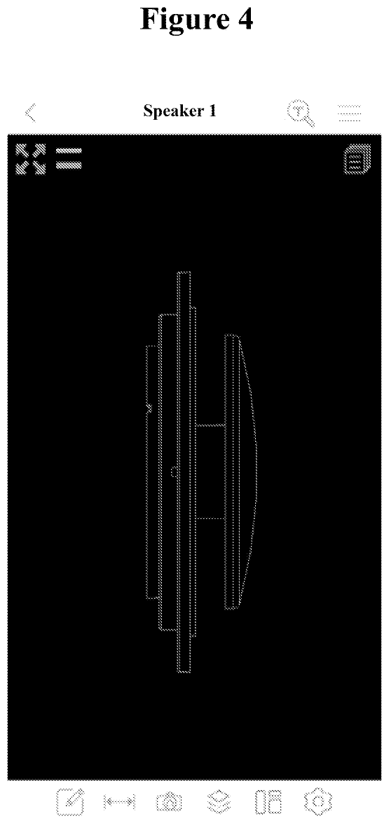

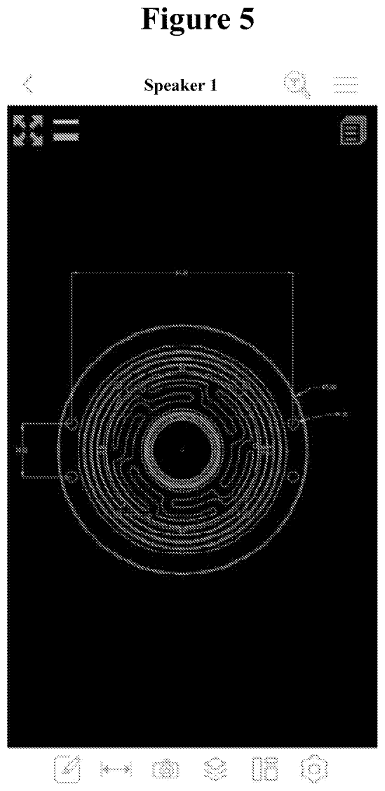

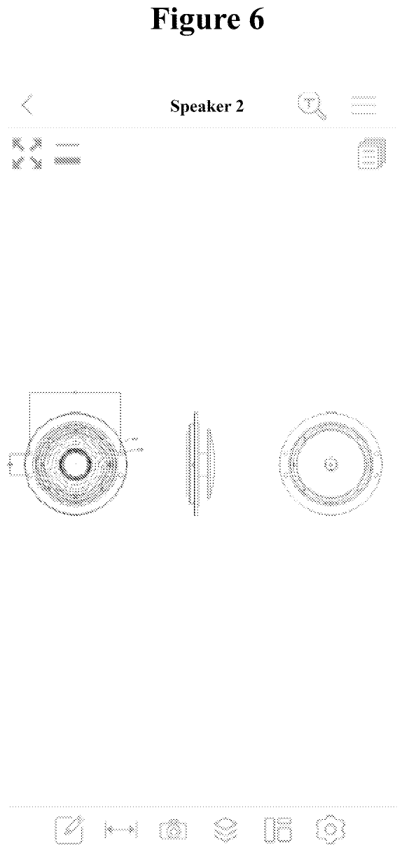

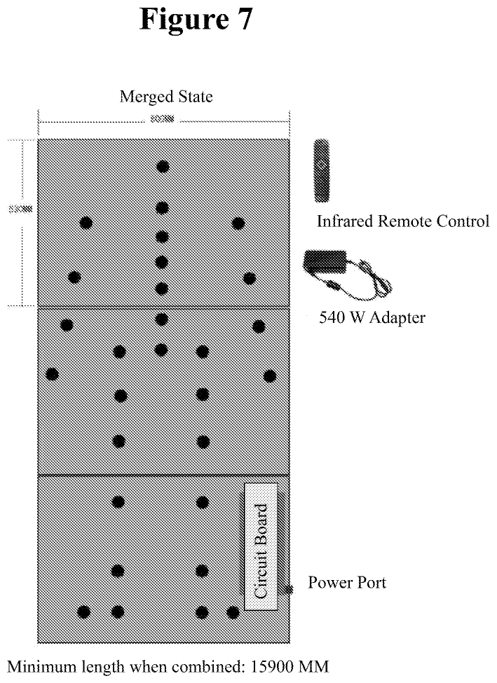

### DETAILED DESCRIPTION OF THE INVENTION

Examining research findings published by academic institutions globally, the World Health Organization made a list of 20 tips for extending life, and singing was at the top of the list. Through a study, the American Center for Gerontology discovered that opera singers' hearts beat more vigorously than the average person's heart and that singing can lengthen life. As early as the 1930s, it was found that the life expectancy of many well-known singers was much higher than the average life expectancy at that time, so it was proposed that singing can make people healthy and long-lived. Modern research has shown that singing has benefits such as increasing lung capacity, improving circulation, regulating mood and boosting immunity.

Researchers at the University of California discovered that after every practice, the immunoglobulin A (IgA) levels of the choir members climbed up by 150%, as well as being 240% more abundant after a performance.

Sound is a type of energy that can open up meridians and acupoints. All things in the universe constantly vibrate and waves, including the cells and molecules found in all kinds of living creatures. Sound waves are a type of qi movement that can directly affect the inner part of the human body in the form of physical energy. Therefore, with the appropriate sound waves acting on the human body, it can also naturally play a role in improving blood circulation and health care.

Expounded scientific principle: Medicine is a substance, and medicine has no light, electrons, atoms, molecules, or quantum fundamentals. Photons, ions, and quantum-level substances belong to basic substances. Medicines are all at a molecular level, they are not fundamental. The fundamental is quantum-level. All molecular-level matters are born, combined, and constructed from quantum-level matter. Lao Tzu clearly says in the Tao Te Ching that something is born from nothing. In this context, “something” refers to matter at the molecular level that is visible, and “nothing” refers to ionic quantized stuff that is invisible. Thus, all matter that is seen is made up of elementary particles that are in the ionic condition of an unobservable quantum state. Singing specifically affects the ionic state and the quantized part of the substance. So, singing can promote health, improve immunity and drive away lesions. The principle is that it deconstructs from the internal structure of the lesion. It deconstructs from the inside, as long as the quantization of the lesion does not exist, the pattern is recombined, then the ionic state does not exist. When the ionic state does not exist, then the atom changes the direction of motion, the nucleus and the electron change the form of contact, exchange, and communicate. When the nucleus and the electron change the form of exchange, the substance changes to a new form, a new style. This is the principle.

Fundamentally, the material world, including light such as sunlight, artificial lighting, candlelight, and firelight, exhibits duality, varying with the environment and becoming a wave. As a result, the photon possesses wave-particle duality, shifting between particles and waves at different times. This phenomenon is known as wave-particle duality. Singing follows this wave-promoting path. For example, when ash is present on a piece of white paper, molecular-level ash can be cleaned by wiping it with a hand or a towel. While the molecular level becomes clean, the atomic level remains unaffected. Mechanical force is ineffective at the atomic level, as it does not cause atomic-scale stimulation. Air can be used next as blowing can remove some of the ash, and if not entirely cleared, blowing again or wiping provides additional cleaning. However, even this double cleaning only achieves cleanliness at the molecular level. Blowing can affect the atomic or ionic states, but it remains ineffective in causing stimulation at those levels. Introducing vibration, such as placing a speaker nearby or singing, breaks down the substance, achieving complete disassembly at the molecular, atomic, and ionic levels. The molecular, atomic, and ionic states—the Trinity—are left immaculate and entirely clean.

While a microwave can heat, no flames are seen. Microwave heating is essentially high-speed vibration. A microwave can also sanitize. That is the wave's underlying theory. The molecular level of our mental states of sorrow, annoyance, resentment, melancholy, sadness, and desolation exist at the quantum and ionic level. Because of this, taking medication has no impact on it. However, by singing and using sound waves, they can be dissembled. It can be vibrated out. Substance exists at the molecular, atomic, and quantum levels. Irritating things cannot be wiped away, cleaned up, or blown away. Only by vibrating can it be removed, only by vibrating can it be broken down, deconstructed, and scattered. Only by vibrating can it be eliminated.

When jogging or working out, the arteries and blood are being worked out. They are at the molecular level. Practicing Taiyi helps purify the blood in the veins at the atomic level. However, to clean those smaller than the atomic level, even tinier, as quantum states, which is microcirculation, only vibration can achieve this. The two simplest forms of vibration are singing and sound waves. Every day, nuns and monks knock on the wooden fish. This may contribute to their clear and unhindered microcirculation, reducing the likelihood of illness. Their arteries, veins, and microcirculation are often in good condition. Before obstructing a vein, everything first fills microcirculation, the tiniest circulation. The artery becomes blocked if the vein is also blocked. Because the channel is so narrow, material first accumulates in the microcirculation. Cleaning microcirculation is essential, as it is where debris is most likely to accumulate. The arteries and veins will be cleaned simultaneously with microcirculation.

In both Chinese and Taoist medicine, the concept of Qi is prevalent. The subtle substances in the human body that are extremely active, constantly moving, immaterial, and invisible are referred to as Qi by Taoist medicine, Chinese medicine practitioners, and practitioners. These substances are the most fundamental ones that make up the human body and support human life activities. This aspect of qi is known as “Qi” ( [symbol] ) so as not to be confused with other qi concepts.

Qi is an ion, and the flow is either a neutral or electrified ion flow. The four common states of matter are solid, liquid, gaseous, and ionic. The fundamental state of matter is the ionic state. Ions, such as sodium, potassium, calcium, chloride, iron, magnesium, zinc, and other ions, are substances in the human body.

Qi is derived from cells.

“For a long time, it has been evident that the answer to all biological concerns must finally be found in cells, because every living thing is or has ever been a cell.” noted renowned biologist E. B. Wilson (1856-1939) in 1925.

Qi contains ten qualities, including yin and yang, fluidity, storage, energy, information, field, periodicity, absorption and distribution, yin and yang interaction, color, etc.

The invisible system, which is based on Qi and uses the meridians as channels and connections, is a more developed system in humans.

The interaction of the human body's tangible and intangible systems is the main characteristic of Qi. The understanding of ions and ion channels in contemporary biology and Taoism medicine's understanding of the role of Qi and meridians in the human body are very consistent and remarkably similar.

Despite that molecular study on cells is now a part of modern biology, ions and ion channels have being studied. On the basis of this, modern medicine has researched ion channel disorders. However, neither has reached the entirety of the invisible system, and neither is aware that ions are Qi, that ion channels are meridians, that ion channels have not been connected to meridians, nor that ion channel disease is a meridian disease. Furthermore, neither has even attempted to reach the invisible system, and neither is aware of the occurrence and development of many diseases in the invisible system. Diseases and treatments resulting from the interaction between the invisible and tangible systems are even more ignorant.

Ancient philosophers' insights and understanding of the cosmos and the nature of life are preserved in the long-standing concept of Qi ( [symbol] ). Since the Yellow Emperor asked Guangchengzi in antiquity, there has been an ancient tradition of examining the nature of existence. This tradition has existed for a very long period. Qi's concept has been passed down by word of mouth for many years by the wise men who sought for the meaning of life, before Cangjie ever invented words. Ancient life sciences were greatly influenced by the concept of Qi, and the Huangdi Neijing contains developed concepts about Qi.

“Taiyi holds the truth Qi, and water was the first matter to be generated in the universe,” said the ancients. A human will either be born or die depending on whether they have Qi or not; a fish will also perish if it is taken out of the water. “Qi” refers to the innate qi rather than the subsequent qi. Postnatal Qi is physical and muddy, while innate Qi is immaterial and clear. Thus, maintaining this real Qi can prolong life.

Qi is a type of healing energy required by the human spirit body in order to maintain health. “Everything in life is vibration,” says Albert Einstein.

Sound is a fundamental component of the universe. Things start to exist because of the sound. This truth has been amply proved by both the most recent advances in physics and the earliest physical research.

In the universe, there is no such thing as matter. Quanta, which vibrates quickly, make up matter. The difference between the two is the vibration frequency, which results in the production of various substances with various consciousnesses or diverse forms. Both the visible and the invisible are constantly vibrating energy. High vibrational substances, like human thoughts, feelings, and consciousness, become invisible; low vibrational substances, like tables, chairs and human bodies, become tangible.

For instance, every atom in the universe vibrates at a particular frequency. The characteristics of this atom are so maintained. The billions of atoms that make up our bodies also each have a unique vibrational frequency. The vibrational frequency of our body is created from the sum of these individual vibrational frequencies. As a result, every human being has a special vibrational frequency, and it is this vibrational frequency that binds all atoms, cells, and organs together to give each portion of the body its specific size and shape.

Any time an organ or body component's vibrational frequency modifies marginally, so does the function of that organ or body part. Beyond a certain point, sickness is produced by the human body. The organ will therefore be able to mend itself and resume normal functioning if its native frequency can be restored. Everyone has slightly varying general body frequencies, albeit the difference is not great. The frequencies of numerous body organs, including my liver and the livers of all other humans, also share a similar frequency. Depending on the location—by the sea, in the mountains, on the plains, in the desert, in a village—and the dietary habits, there may be some variations in the frequencies. These elements will alter the frequency of a certain body organ. Body organ frequencies fall within a typical range of values. Organs malfunction when the frequency fluctuates outside of the normal range, and people get sick.

There are vibrational movements of energy throughout nature, the universe, and the cells in the human body, as proved by modern cell biology and quantum physics. By regulating vibrations, sound therapy serves as a method to help the body regain vitality and equilibrium. When harmony, resonance, and balance are maintained, the body functions optimally. Life remains straightforward and fulfilling when the body's organs work in unison and support one another. As a result, any slight change in the vibrational frequency of a body part affects the function of that organ or part. Beyond a certain threshold, such changes can lead to illness. Therefore, restoring an organ to its normal frequency enables self-healing and the resumption of normal functioning. When the human brain conducts in thinking activity, two things are produced simultaneously: consciousness and brain waves.

From a brain physiological point of view, consciousness is both old and new complicated information that has been stored on the plastic brain physiological structure, such as the synapses of brain nerve cells. It can only be found in the brain and cannot live outside the body. For brain nerve cell synapses to transmit information and analyze information flow, brain waves-a type of bioelectricity—must be stimulated and in a state of activity.

β Waves˜The majority of the electrical activity in the brain during a normal state of awareness, such as when reading, talking, or driving a car, is in the range of 14 Hz, which is obviously an approximation. There is activity at every frequency, but the majority occurs between 12 and 16 Hz.

α Waves˜Its frequency is between the Schumann wave range of 8 to 13 Hz. Instead of being a single frequency, this is a range. This frequency range is associated with peaceful meditation or just closing the eyes. The human body can simply resonate with the Schumann wave between the heavens and the ground when it is in the Alpha wave condition (eyes closed+relaxation+ concentration). Between the heavens and the earth, endless Schumann waves exist. The human body's bioelectric field continuously charges (absorbs the essence of the sun and the moon) if it frequently resonates with the Schumann wave.

θ Waves˜Brain waves will change to the theta range, which is typically associated with deep sleep or unconsciousness, when the mind is extremely relaxed, with an intermediate frequency of 4 to 6 Hz. Many alleged supernatural powers are reported to manifest in this state.

δ waves˜Delta waves, which have frequency between 1 and 3 Hz, are the most tranquil brain states. It was once thought to be associated with unconsciousness and deep slumber. However, some deep meditators can maintain this state while still being fully awake, and many people think that this state opens up psychic information and modifies perception.

Therefore, meditation, which is recognized as a part of the world intangible cultural heritage, can efficiently release the “low frequency waves,” or theta and delta waves, from the cerebral cortex and balance the high wave frequencies of the brain.

Cell Acoustics is a concept that is profound and is becoming better understood by modern society. It is regarded as one of the most significant medical discoveries of the twenty-first century.

According to a 2004 study by Professor Gimzewski in the journal Science, the team studied yeast for two years and discovered that cells always cycle through different stages of life at roughly the same frequency. This movement manifests as sound, occurs in a certain frequency range, and these frequencies have a unique significance.

The shift in vibrational frequency is a crucial sign of cell health from the perspective of Cell Acoustics. Healthy cells have a standard resonant frequency between 1.8 Hz and 8.2 Hz, known as the “Cell Song”. While cells that are wounded will “squeak” and “groan” before the cell dies. Cancerous cells emit noise while they grow. Due to its enormous advancement, Professor Gimzewski's Cell Acoustics is regarded as one of the most significant medical discoveries of the twenty-first century.

The TYQA sound wave smart acupuncture device developed by Mr. Zhang Xunhua has been granted a US patent for invention. The foundation of its technology is the utilization of cutting-edge methods for gathering and extracting the “Qi” and “Cell Hertz” of human's life and amplifying them 1,000 times. Placing the TYQA series of sound wave of specialized vibration frequency devices at the spot of human disease, harmoniously resonate with the cells and brain waves, reducing mental stress and varied pains, enhancing the physical and mental well-being.

The TYQA Sound Wave Smart Acupuncture device was inspired by the principle of Taiyi Qi Acupuncture, an intangible cultural heritage that dates to ancient Chinese acupuncture and moxibustion. It works on key acupoints on the human body by using Qi wave vibration rather than the twirling, lifting, and thrusting of needles used in “acupuncture” and by using sound wave energy rather than heat energy used in “moxibustion.” It simulates conventional acupuncture therapy by transmitting energy waves to the body's organs, stimulating the body's own regulating mechanisms. It will not burn or puncture the skin while in use. It also has no negative side effects. Controlled through the mobile website/APP. It avoids the drawbacks of conventional acupuncture and moxibustion therapy while obtaining the effects of relaxing the body and mind, alleviating, treating pain, etc.

The TYQA sound wave smart acupuncture device's appearance, form, and size have all been carefully examined and considered. It adopts the principle of double action on the top and bottom. The top point is suitable for usage on the perineum, navel, pubic bone, head, and face, among other places where points are required. The bottom plane is suitable for the soles of the feet, the inner and outer sides of the calves, the inner and outer sides of the arms, the groin, the waist, the Danzhong point, the chest cavity, the neck and other plane parts. Open and use anytime, anyplace with a portable design. It is appropriate for those who desire to embrace a green, non-invasive kind of healthcare. It has obvious improvement effects on insomnia, poor blood circulation, low immunity, pain and other symptoms.

Mr. Zhang Xunhua developed the TYQA brainwave magnetic ring device, which emits ultra-low frequency sound waves using specific headphones. The sound wave from the headphones is played and the frequency received by the special energy magnetic ring of the same frequency which is placed in the position of the human body's heel and the finger. It then resonates at the same frequency, reaching the wave from head to foot.

The TYQA bone conduction technology tracks different frequency waves and employs the “pendulum clock effect” to resonate with the frequency of the brain. In actuality, the locations along the meridians where they are not smooth are where the body emits waves of various frequencies, giving rise to the perception that the blocked areas are receiving massage. Internally massaging the skull over a long period of time prevents cerebral infarction and lowers the risk of stroke.

Why are the energy magnetic rings applied to the acupuncture points on the foot along the kidney meridian? Chinese medical thought holds that the brain and bones are governed by the kidneys. The magnetic rings placed on the “Yongquan Point” and “Taixi Point” along kidney meridian daily resonate with the brain waves. Bioresonance will occur.

Mr. Zhang Xunhua has conducted extensive research and developed a variety of wearable high-tech devices that are all non-intrusive, non-mechanical, and have been applied successively. Devices called brainwave magnetic rings are developed to massage individuals in places that therapists can't achieve. long-term use to enhance cerebral blood flow.

Products that successfully produce “Brain Waves” can have an impact on the cardiovascular system. In muscle and adipose tissue, the vibration of sound waves can boost lipase activity, and facilitate the transfer of phospholipids and cholesterol to high-density lipoprotein. Transferring the cholesterol that has built up on vessel walls to the liver for breakdown is extremely important, because it can effectively stop or delay the onset and progression of cardiovascular and cerebrovascular disorders such arteriosclerosis and hypertension.

Brain Waves can have an impact on the respiratory system. Resonance of the sound waves will improve the efficiency of gas exchange between the alveoli and the capillaries surrounding the alveoli, expand lung capacity, and have an impact on the lung's ventilation function, diaphragm activity amplitude, respiratory rate, gas metabolism, etc. can increase blood circulation, improve internal organ performance, and boost the respiratory center's excitement, which can influence and regulate the autonomic nervous system.

Brain Waves can have an impact on the digestive system. Sound waves can improve digestion and absorption, decrease sympathetic nervousness, somewhat raise vagotonia, encourage the release of digestive enzymes by the digestive glands, increase bowel noises, and boost appetite. The frequency of gastrointestinal motility is increased and the time it takes for the stomach to empty is decreased since the vagus nerve is primarily responsible for controlling the digestive system. When using resonance to breathe through the abdomen, the diaphragm's range of motion is increased, its range of motion is expanded, the range of intra-abdominal pressure changes is increased, and the mutual extrusion and friction of the internal organs can effectively promote the blood circulation of the internal organs. Adjust the gastrointestinal system's function by using the visceral receptors' nerve reflex. Long-term use is therefore very beneficial for regulating and enhancing processes like digestion, absorption, and elimination.

Some series of TYQA equipment are user-friendly and belong to non-invasive, non-drug sound wave natural therapy. (The copyright of sound wave therapy was protected by the Chinese National Copyright in 2011 and by the United States Patent in 2021.)

Everything in the universe, including cells and molecules in various life forms, are constantly vibrating and fluctuating. Sound wave TYQA is a type of physical energy that directly affects the vibration of human cells.

Sound waves can cause the vibration systems of various organs in the body to produce beneficial resonance and achieve coordination and balance in various frequency rhythms in the body. It is a natural health massage that promotes blood flow to diseased organs and transforms the body from unhealthy to healthy.

From a chemical perspective, when sound waves enter the brain, they can excite the neural excitatory parts and promote the secretion of active substances such as enzymes and hormones that are harmful to health through the regulation of neural fluids. This improves the function of the nervous system, endocrine system, and digestive system, and can also change a person's mental state to achieve a healthy goal.

From a biological perspective, when cells are at rest, the exterior of the cells are positively charged, and the interior is negatively charged. Under the influence of sound waves, cells become excited and their electrical potential changes. Secretory cells can secrete more beneficial substances for the body, making muscles stronger, promoting the release of adenosine triphosphate (ATP) energy, and making the activity of various organs more coordinated.

From the perspective of Traditional Chinese Medicine, sound is an energy carrying life information, and when sound waves are input into any point along a meridian, they travel along that meridian. TCM treatments such as acupuncture and acupressure are designed to stimulate acupoints to unblock meridians, allowing energy to flow smoothly throughout the body and preventing illness. Similarly, acupoints can be stimulated and meridians unblocked through the vibration of sound. When the frequency of sound vibration continues to oscillate in the meridians and acupoints, each acupoint is stimulated open, transmitting the sound vibration to the next acupoint and meridian along the pathway. In this way, the meridians and acupoints throughout the body are opened, qi and blood flow smoothly, the five internal organs are regulated, and both body and mind achieve a state of health. This is the so-called “maintaining positive energy and preventing evil from entering.

### 1. The Impact of “TYQA” on the Cardiovascular System:

TYQA sound wave vibrations can increase the activity of lipases in muscle and fat tissues, promoting the transfer of cholesterol and phospholipids to high-density lipoproteins. This change is significant in transferring cholesterol deposited on the blood vessel wall to the liver for degradation and can effectively prevent or slow down the development and progression of cardiovascular and cerebrovascular diseases such as arteriosclerosis, thrombosis, and hypertension.

Due to the slow and continuous rhythm of the sound wave and its moderate intensity, this sustained muscle movement can both increase the strength of heart muscle contraction and have a positive effect on cardiac pumping capacity. It also increases the return of blood to the heart, reduces the tension of small blood vessels and coronary arteries, restores the elasticity of arterial walls, lowers arterial blood pressure, and thus improves blood supply to the heart and enhances the heart's working capacity.

### 2. The Impact of “TYQA” on the Respiratory System:

TYQA sound wave resonance can enhance lung capacity, improve the efficiency of gas exchange between alveoli and capillaries around the alveoli, have a good impact on pulmonary ventilation function, diaphragm activity amplitude, breathing frequency, gas metabolism, etc. It can also promote blood circulation, enhance the function of internal organs, and stimulate the excitement of the respiratory center, affecting and regulating the autonomic nervous system.

### 3. The Impact of “TYQA” on the Digestive System:

TYQA sound waves can reduce sympathetic nerve tension and increase parasympathetic nerve tension, increase digestive enzyme secretion of digestive glands, enhance gut sounds, improve appetite, and enhance digestive and absorption function. Because the digestive system is mainly controlled by the vagus nerve, the frequency of gut peristalsis increases, and the gastric emptying time decreases. After each exercise, bowel movements are very smooth, which is evidence. Due to the use of resonance, the amplitude of diaphragm muscle activity increases during abdominal breathing, the range of diaphragm muscle activity expands, and the change in intra-abdominal pressure increases. The mutual compression and friction of viscera can effectively promote the blood circulation of viscera and adjust the gut function through the sensory reflex of viscera receptors. Therefore, long-term use is of great benefit in adjusting and improving digestive, absorption, and excretion functions.

Despite the hundreds and thousands of protein molecules within human cells, they all have poles: N poles and S poles, which are Yin and Yang.

TYQA mainly works on the micro-circulation of the human pelvis and limbs, using N poles and S poles to form a strong Yin and Yang energy magnetic field. By using TYQA to resonate with the frequency of human cell vibrations, it can improve the micro-circulation of the human limbs and enhance the body's immunity. The strong Yin and Yang energy magnetic field can also unblock the whole-body meridians and prevent the formation of blood clots.

Wang Guiqiang, professor and director of the Infectious Diseases Department of Peking University First Hospital, pointed out that increasing immunity and scientifically controlling thrombosis measures can not only defeat the novel coronavirus but also respond to more virus and bacterial threats, making humans healthier and longer-lived.

Conventional medicine has developed rapidly, but there are still many diseases that are considered incurable and easy to control. In these cases, the symptoms are the target of conventional medicine—the disease itself is not stopped. At the same time, it should be noted that conventional medicine is known to cause many adverse reactions-sometimes even causing damage to certain structures of the human body. This is the main reason why many people turn to alternative options-usually in the form of “alternative therapies” or holistic methods to assist in the management and treatment of their conditions.

In the past few decades, sound wave resonance therapy has become a popular holistic treatment service. Many patients have been able to experience positive results with the help of this technology. For patients who have only recently noticed this therapy, it is very important to understand how the technology works and what to expect from sound wave resonance therapy. This can help patients decide whether this is a holistic method for treating diseases that they may want to invest in.

Sound wave resonance therapy focuses on the idea behind the origin of disease—that is, unhealthy vibrations in the body. These unhealthy vibrations are caused by the presence of toxic substances in the body. These substances can be in the form of parasites, bacteria, heavy metals, viruses and many other substances. The technology was developed after quantum physics experts discovered that every particle that exists in the human body tends to emit a wave—an electromagnetic signal with a unique frequency and wavelength.

Life Wave treatments can often offer patients an effective way to address the underlying issues that cause disease and other illnesses. Many patients are using these treatments as an alternative to traditional medicine, hoping to find relief for their specific illnesses and symptoms without having to expose their bodies to potentially harmful drugs. Life Wave resonance is a specific form of holistic healing that is becoming increasingly popular—and it is important for patients to understand how this type of healing works compared to other types of holistic healing.

Life Wave is a safe, gentle, non-invasive alternative healing technology designed on the premise that all particles of matter generate electromagnetic energy. In humans and other animals, this electromagnetic energy is constantly resonating from the body in oscillations of different wavelengths and frequencies that can be detected, amplified, mapped and examined.

The findings of quantum physics show that all particles of matter have characteristics of both waves and particles. This means that all matters—as well as all body cells, body parts, as well as viruses, bacteria, pollen, toxins, etc. —emit electromagnetic waves. All substances have specific typical wavelengths or frequencies that are highly individualized, depending on their properties, which are called frequency patterns.

For example, the heart plays a vital role in the human body. It ensures that all parts of the body receive an adequate supply of blood rich in oxygen and nutrients. When the heart is not functioning adequately, many adverse reactions may occur in the patient's body. Some heart diseases are more common than others. Education about the most common symptoms that may indicate heart disease can ensure early detection and treatment; thereby reducing the severity of damage caused by this disease to the heart and other parts of the body. By using “Life Wave” resonance therapy, stressors, toxins and other negative factors can be identified and eliminated; thereby improving overall heart health and may even relieve some of the symptoms that patients may experience.

The technology determines the balance of internal organs by sending “Life Waves” throughout the body.

In the case of a patient with breast cancer, Life Wave Resonance Therapy can be used to analyze interfering substances and how they affect the patient's body. This technology will identify objects that cause poor health, including bacteria, allergens, heavy metals, viruses, electronic smog, etc. Life Wave Resonance Therapy can help determine the most effective treatment for breast cancer in a specific patient.

Both male and female patients are at risk for breast cancer, but female patients are at a much higher risk than male patients. When the condition is diagnosed at an early stage, treatment may be more effective, so patients are advised to seek medical attention when symptoms occur. Life Wave Resonance Therapy can also be used to thoroughly examine and diagnose the development of a patient's cancer.

Life Wave Resonance Therapy can be a complementary treatment option for patients with breast cancer.

Discoveries in quantum physics show that all material particles have characteristics of both waves and particles. Depending on their properties, all matters have a specific wavelength or frequency with highly personalized characteristics.

Life Wave Resonance Therapy has been proven to be an effective method to enable the body to heal itself by amplifying healthy electromagnetic signals and reversing unhealthy signals. The treatment is cost-effective, and many patients experience benefits after only a few sessions. The treatment does not cause any serious side effects, and those patients who do experience some adverse effects after treatment quickly return to their normal functional status.

Additionally, the ancients called Qi a kind of innate Qi with magical functions in the human body. Qi is the root of human life, the source of creation, and the basis of life and death. This magical Qi in the human body is the control system of human life substances. It is a bit like the Windows operating system on a computer.

Regarding the importance of Qi to human life, a deeper understanding can be gained from the following aspects: from the relationship between Qi and meridians.

In the three major systems of human life science: the appearance of a person is tendons, bones and skin, which are nourished by the five internal organs; the essence of a person is the meridians, which are driven by Qi. This means that when the innate Qi is full and sufficient, the operation of the meridians is unobstructed. The meridians of the human body are a complex giant system. It delivers nutrients to the metabolism of cells such as the five internal organs, bones, flesh, tendons, skin, and hair, takes away waste, and ensures the normal operation of the metabolism of various cells. At this time, people are healthy.

But when the Qi weakens, the meridians lack power, which leads to stagnation. The metabolism of cells at the stagnant points, lines and surfaces is affected, and they become the place where diseases occur. This shows the important role of the innate Qi in life. Therefore, Qi is the root of human life, the source of creation, and the basis of life and death. The great significance of sound wave therapy is that the human body is a complex vibration system, which also resonates in this way and responds to many different frequencies. Many parts of our body and different physiological systems have their own resonant frequencies, which are mixed together to produce the resonance or vibration frequency of each person. Sound wave therapy is based on the theory that everything is vibrating. Almost all sound wave therapy adopts the method of strengthening the natural and correct resonant frequency of human physical, emotional, psychological and spiritual body. These resonant frequencies can control the energy of bad cells and restore them to a healthy state. This sound wave therapy can effectively deal with the resonant frequency of bacteria and viruses that invade the body. When the healthy resonance of the organ becomes stronger, the invading virus becomes weaker and is destroyed. Sound waves are a kind of sound wave nutrition that can nourish our body, mind and spirit. Some sound waves dominate and affect our brain and nervous system. Just like taking the right medicine for the right disease, the same principle applies to sound wave treatment. Different sounds are to be used for different diseases. Sound waves are multidimensional and can affect many aspects at the same time, such as physiology, emotions, and psychology. Because of different vibration frequencies, different sound waves are needed to vibrate the meridians and dredge the collaterals. Taiyi Qi needle waves follow the laws of information, energy, and consciousness, and use consciousness waves, energy waves, and sound waves to achieve the coordination of body, mind and spirit. It uses information guidance, consciousness guidance, and energy amplification. It uses the principle of high-frequency resonance to input sound waves with positive energy magnetic vibration as consciousness guidance, which resonates with the human body's biomagnetic field to shake off lipids, plaques, and toxins in the microcirculation, improve the circulation of qi and blood, and regulate the imbalance of body and mind. The three waves of consciousness wave, energy wave and sound wave are coupled to produce high-frequency vibrations up to hundreds of millions of times per second. This high-frequency vibration sounds like noise and cannot be perceived by the five senses of the human body, but it can open up the meridians and has a huge effect. Active exercise is used to practice “Qi”, and “waves” are used to open up the meridians and activate the meridians. Both are indispensable. Low frequencies (1-20 Hz) are critical to the health and are among the many frequencies used in this method and employed by the device. The frequency, amplitude and duration of the wave can all be adjusted. Specially, the amplitude can be amplified multiple times, for example, 10, so that the waves are strong enough for personal likes and in some cases for better therapeutic results. This is applicable to all the following embodiments and other embodiments not listed here.

In one embodiment, the infrasonic waves are generated and emitted from four speakers housed in a mat, the mat being a soft spongy material. The speakers can be turned on and off by a control, remote or connected to the mat. The mat can be placed on the ground, on the chair, or on other surfaces. The mat can also be secured to the torso or limbs of a human. The frequency of the infrasonic wave is set by the physician and the patient can adjust the intensity of the waves and the time when the speakers will be turned off. The patient can place his/her feet on the mat, sit on the mat, place the mat behind the back, or wrap the mat around the torso or the limbs. The frequency, amplitude and duration of the wave can all be adjusted.

In one embodiment, using the device above, hypertension can be moderated. In the morning, the patient places the device on the ground, and place the feet on the device for about an hour. The patient then places the device on the chair, and sits on the device for about another hour. For optimal results, the tailbone should be aligned with the device, and the patient should sit straight. At night, the patient places the device sideways at the feet and time for one to three hours. The device will stop automatically after the patient falls asleep.

In another embodiment, using the same device, various pains and osteoarthropathy can be moderated. The patient places the feet on the device for about an hour, and then sits on the device for another hour. The tailbone should be directly against one embedded speaker. This helps alleviate various types of pain. The patient then places or secures the device directly on the painful area for one hour. This can help reduce or eliminate pain to varying degrees. The duration of use may vary depending on the type of pain and the individual. Prolonged and consistent use over multiple days can further alleviate or eliminate pain.

In another embodiment, two of the above devices are used simultaneously. This method can moderate diabetes, prostate, breast disease, varicose veins, thyroid nodules, gynecological diseases, uterine fibroids, constipation, male and female reproductive problems. In the morning, the patient places a first device on the ground, and places the feet on the device. The patient then places the second device on the chair and sits on the device with the tail bone directly against a speaker on the device for optimal results. The patient remains seated with the feet on the first device for about an hour. At night, the device is placed under the feet and timed for one to three hours while a second device is placed on the abdomen and timed according to the patient's habit of use. The intensity of the infrasonic waves can be adjusted by the patient based on his or her preference. The second unit can be placed on the abdomen, and the use time and energy amount can be set according to the habits to achieve natural sleep. After using it for ten days, the body will show different levels of adjustments, and the symptoms will be relieved and alleviated after using for more than 30 days. Six months of use will result in a 70% recovery rate. One year of use will achieve an 80% recovery rate. A recovery rate of 96% is achieved after two years of use.

In another embodiment, the device is in the form of a bed or a table where patients can lie supine and the speakers are embedded to align with the outline of body. In one embodiment, the number of the speakers are 30. The speakers can generate or emit sounds at the infrasonic frequencies set by the physician for moderating different situations and symptoms. To use this method with the device, the patient can lie on the device for 1-3 hours during the day, and for an additional 3 hours at night. The patient can be asleep while using the device. This method with this device can moderate cancer, heart disease, coronary heart disease, myocardial infarction, chest tightness and shortness of breath, palpitations, cerebral infarction, stroke, cardiovascular and cerebrovascular diseases, femoral head necrosis, herpes zoster, microcirculation disorders, etc. After one month of use, the symptoms will be relieved. It will take one year to achieve a 50% recovery rate. After two years of use, a recovery rate of 70% will be achieved. A 90% recovery rate will be achieved after three years of use.

In one embodiment, the method uses a device in the form of a headset, and the speakers are embedded in that headset. The device can be worn on the head like a conventional headset or applied to other parts of the body, such as the lower back, shoulders, or legs, and is sturdy enough to be sat on in a riding position. The device features a lightweight yet durable frame constructed from flexible, biocompatible materials that contour comfortably to different body parts while ensuring stability during use. Integrated within the structure are precision-tuned transducers capable of emitting life waves or electromagnetic pulses, designed to stimulate circulation, relieve pain, and enhance cellular repair. The frequency, intensity, and duration of wave emissions can be adjusted via a digital control interface, allowing users to personalize their treatment based on specific needs. Strategically positioned wave-emission nodes ensure optimal energy delivery whether the device is worn on the head, placed against the back, wrapped around limbs, or positioned for seated use. The headset is powered by a rechargeable battery, making it portable and convenient for extended therapy sessions. Its ergonomic and modular design allows for seamless adaptation to different body regions, ensuring effective treatment for various musculoskeletal and neurological conditions. Designed with medical-grade safety features, including automatic shut-off and overload protection, the device ensures a secure and controlled therapeutic experience. The multi-functional wave-emitting headset represents a breakthrough in personalized therapy, combining advanced wave technology with adaptability to offer a versatile solution for pain relief, relaxation, and recovery.

In one embodiment, a stomach speaker with handles is a compact yet powerful device designed for targeted treatment through the emission of life waves or electromagnetic pulses. Slightly larger than a basketball, this spherical device is ergonomically designed to be placed on the stomach or other body areas, delivering deep-penetrating therapeutic waves to promote relaxation, pain relief, and tissue recovery. Constructed from high-density, medical-grade materials, the speaker features a smooth, contoured surface that conforms comfortably to the body while ensuring stability during use. Embedded within its core are precision-calibrated transducers capable of generating life waves, optimized for deep tissue stimulation and improved circulation. The intensity and frequency of the emitted waves can be adjusted via an intuitive digital interface, allowing users to tailor treatments based on their specific needs. The device operates wirelessly, powered by a rechargeable battery, enabling convenient and portable therapy sessions without limitations of cables. Its balanced weight distribution ensures effective contact with the body, while internal vibration-dampening technology prevents unwanted resonance. Designed for therapeutic applications, the speaker provides a non-invasive and soothing treatment experience. With built-in safety features, including automatic shut-off and temperature regulation, it delivers controlled and consistent therapy, making it an effective tool for home wellness routines, rehabilitation centers, and professional therapeutic settings. The speaker is equipped with an ergonomically designed handle integrated into its structure, allowing for easy portability and versatile use. The handle provides a secure grip, making it effortless to carry, position, and adjust the device on different body areas. Its durable yet lightweight construction ensures stability during therapy sessions while maintaining user convenience.

In one embodiment, the device is a therapeutic soundwave-emitting speaker designed to be mounted on a tripod and placed in a room to deliver targeted life waves for relaxation, pain relief, and overall well-being. The use of this device with this method benefits everyone in the room, allowing for group therapeutic sessions. The device features an adjustable intensity setting, allowing users to customize the strength of the waves based on their therapeutic needs, as well as a programmable duration function to control session length. Its tripod compatibility ensures stable positioning at an optimal height and angle for effective wave distribution, making it suitable for home wellness, rehabilitation centers, and professional therapeutic environments. With a sleek, modern design and user-friendly controls, the speaker provides a non-invasive and effortless therapeutic experience, creating a soothing atmosphere for relaxation and recovery.

In one embodiment, the device is in the form of a helmet delivering targeted life waves waves or electromagnetic pulses for neurological and musculoskeletal treatment. Shaped like a helmet, it features embedded precision-engineered transducers that emit deep-penetrating therapeutic waves to stimulate circulation, reduce inflammation, and promote cellular repair in the head and surrounding areas. The device offers adjustable intensity settings, allowing users to tailor the treatment to their specific needs, while an integrated timer enables controlled session durations. Made from lightweight, breathable, and hypoallergenic materials, the helmet ensures comfort during extended use while maintaining a secure fit. Its versatile design allows for non-invasive therapy aimed at conditions such as migraines, stress relief, cognitive enhancement, and overall neurological wellness. Suitable for home, clinical, and rehabilitation settings, this innovative device provides a convenient, hands-free therapeutic experience for enhancing relaxation, pain relief, and mental clarity. “Spirit, mind, and body”, it uses high-tech brain nerve conduction technology to install the TYQA device in the helmet. The information waves released by the device resonate with brain cells and then transmit to cells throughout the body. The sound waves regulating the mind and body are transmitted through the frequency of the vibration of the internal organs of the “heart, liver, spleen, lungs, and kidneys”, which plays a role in regulating the mind, body, and spirit and activating the regenerative cells throughout the body.

In one embodiment, the device is in the form of a pillow, with speakers embedded in the pillow deliver targeted life waves for relaxation, pain relief, and overall wellness. Shaped like a conventional pillow, it features embedded high-precision speakers that generate deep-penetrating therapeutic waves, stimulating circulation, alleviating muscle tension, and promoting cellular repair. The soft, ergonomic design ensures maximum comfort while providing effective therapy for the head, neck, back, or other body areas. Users can customize their treatment by adjusting the intensity of the waves to suit their specific needs, while a built-in timer allows for controlled session durations. Made from hypoallergenic, breathable materials, the pillow is suitable for extended use and can seamlessly integrate into daily rest or sleep routines. Designed for home, clinical, or rehabilitation settings, this non-invasive therapeutic pillow offers a convenient and soothing approach to managing various medical conditions, including chronic pain, stress, and sleep disorders. The pillow uses “bone sensor guided sleep waves” and “wrinkle-free pillow” Sleep for youth, pillow for health! Patented Qi wave technology, bone conduction activates brain vitality and resonates with cells at the same frequency; enhance blood circulation, nourish the brain and facial skin; anti-wrinkle black technology, say goodbye to skin nodules, welcome firmness and smoothness.

In one embodiment, the device is in the form of a cushion, where the wave generators and emitters are embedded. Patients can sit on the cushion, put the cushion behind the back, or places the cushion on the legs, just as how the patients like to use with a regular cushion.

In one embodiment, the device is in the form of a mattress, emitting bone sensing+brain conduction+Qi wave pillow+reproductive wave which activates regenerative cells and start a lifelong disease-free fitness life. “Bone sensing bed”: Under the Qi wave cabin is the “bone sensing mattress”, which can be used alone or in combination (according to each person's needs). Function: “Body, mind, and spirit”, it uses bone sensing high-tech technology to lay the TYQA device in the mattress, the information waves released by the device resonate with the bones of the whole body, allowing the sound waves of meditation and spiritual communication to be transmitted to the heart and spirit through the tendons and fascia of the whole body, achieving the effect of solidifying the soul and spiritual communication.

In one embodiment, the device is in the form of a ball. The reproductive Qi wave ball is the only most convenient, effective, and safe non-invasive reproductive health solution with the US national copyright. Function: The reproductive Qi wave ball is placed in the human pelvis, and the powerful Qi wave can impact the cold and damp turbid air in the abdominal cavity. The resonance of the Qi wave and the pubic bone will dissolve the fascial nodules around the pubic bone and make the meridians unobstructed. The Qi wave has a special effect on the perineum point. The energy of the Qi wave can be opened from the perineum point to the Baihui point, making the central channel of the human body play a great role.

In one embodiment, the device is in the form of a capsule and provides immersive therapeutic experiences using life waves or electromagnetic pulses. The capsule is configured to simulate motion, such as acceleration, deceleration, rotation, or tilt, to create a dynamic environment for the user. The capsule further includes sensors to detect the position and movement of the user, and the motion control unit adjusts the actuator system to deliver a corresponding response based on the detected data, thereby providing a simulation of real-world motion or motion-based events. The capsule may also include an audio and/or visual system to enhance the immersive experience, synchronized with the motion for a more realistic simulation. Shaped like a capsule that can comfortably house a full human being, the device envelops the body in a secure and controlled environment, delivering targeted therapeutic waves to stimulate circulation, relieve pain, and promote overall wellness. Inside the capsule, emit deep-penetrating waves are emitted by the various embodiments listed above such as pillows, mattresses, headsets, pelvic balls, and additionally by the wave generators embedded in the capsule itself to reach various body tissues, enhancing cellular repair, reducing inflammation, and improving muscle recovery. The intensity of the waves and the duration of the therapy session can be easily adjusted through a digital control interface, allowing users to customize their treatment to suit specific conditions such as chronic pain, stress, or sleep disorders. The capsule is made from medical-grade, hypoallergenic materials designed to ensure comfort and safety during use. It is equipped with advanced features such as adjustable temperature controls, air circulation, and built-in safety mechanisms to enhance the user experience. Ideal for home, wellness centers, and clinical environments, this immersive, non-invasive therapeutic capsule offers a holistic approach to healing, promoting relaxation, recovery, and overall health.

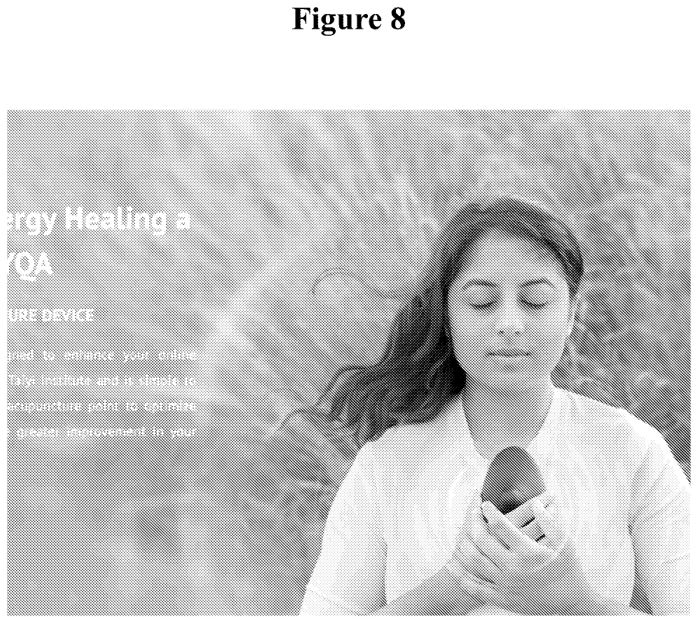

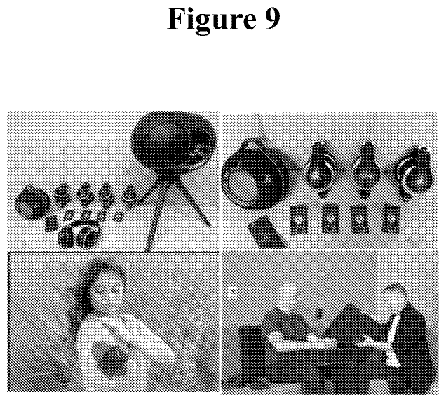

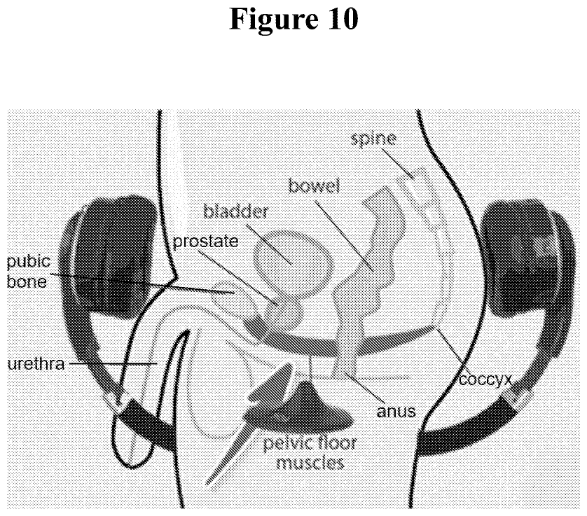

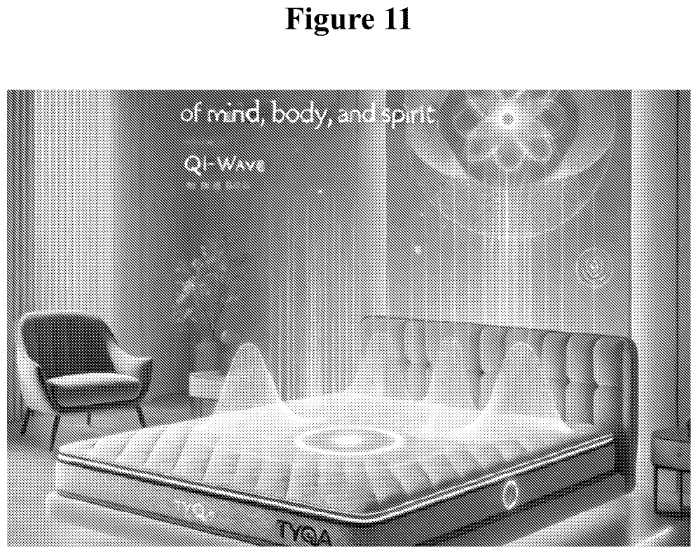

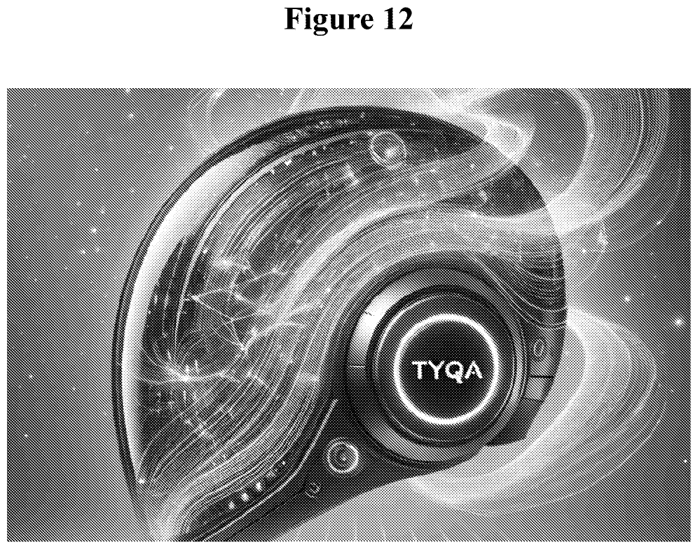

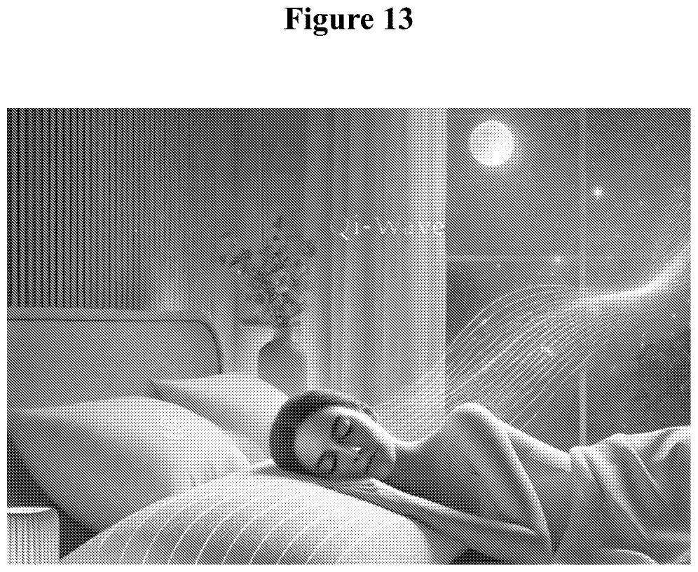

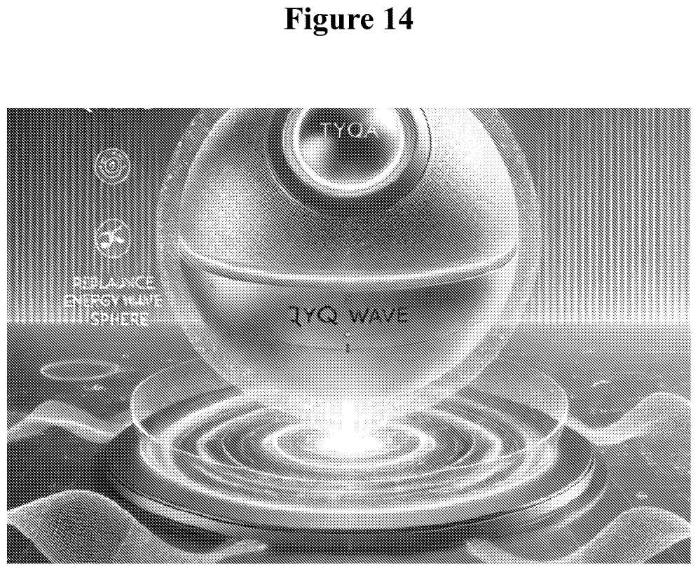

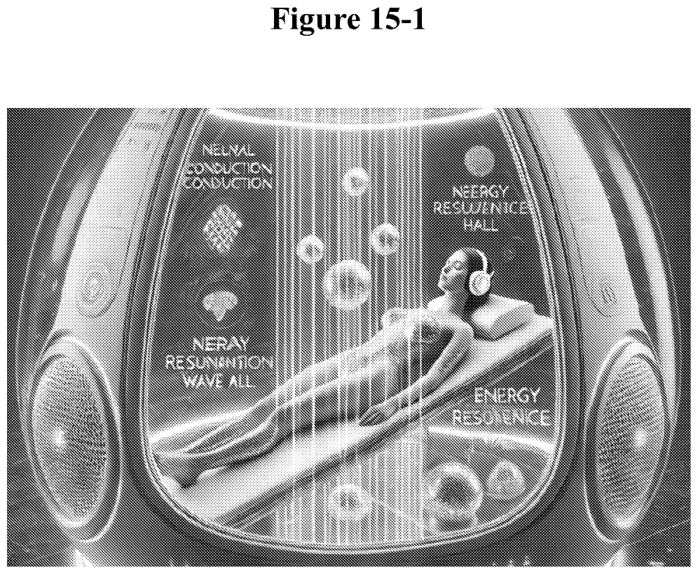

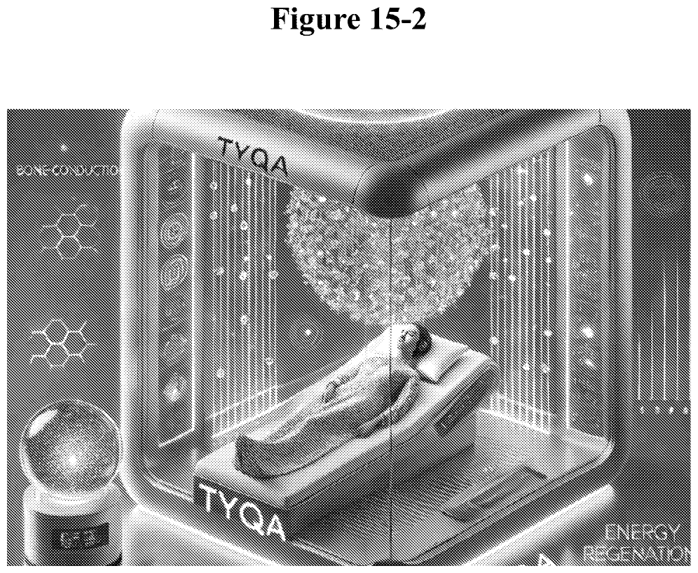

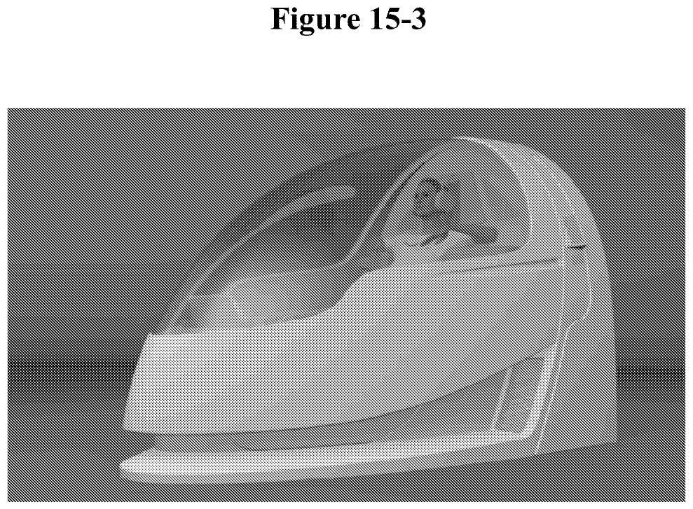

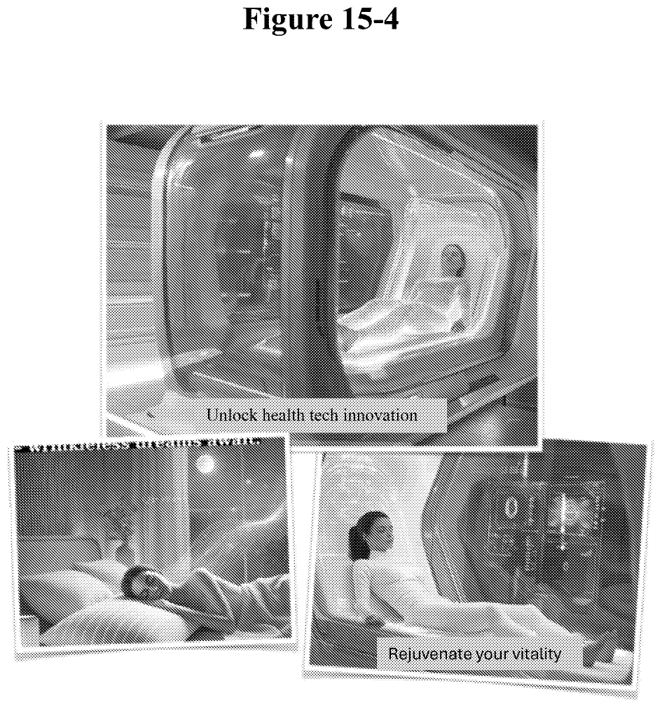

In one embodiment, the waves are generated and emitted from a device such as a device for acupuncture and moxibustion therapy, or any other devices as shown in FIGS. 8 and 9.

TABLE 1
Wavelength and duration of treatment for different conditions.

| | | Duration of | | |
|---|---|---|---|---|
| Indication | # of Subjects | Treatment | | Wavelength |
| Hypertension | 80 | 6-8 | months | Life Wave A |
| | | | | 15 Hz |
| Various pains | 260 | 1-3 | months | Life Wave A |
| | | | | 10 Hz |
| Cervical | 160 | 10-30 | days | Life Wave A 5 Hz |
| spondylosis | | | | |
| Lumbar | 200 | 1-3 | months | Life Wave A 4 Hz |
| spondylosis | | | | |
| Various | 180 | 1-3 | months | Life Wave A 4 Hz |
| osteoarthritis | | | | |
| disbetes | 80 | 3-6 | months | Life Wave B 3 Hz |
| prostate | 80 | 3-6 | months | Life Wave B 3 Hz |
| mastosis | 100 | 3 | months | Life Wave B |
| | | | | 10 Hz |
| Varicose veins | 120 | 3-6 | months | Life Wave B 3 Hz |
| Thyroid nodules | 70 | 1 | month | Life Wave B 5 Hz |
| Gynecological | 200 | 3-6 | months | Life Wave B 2 Hz |
| diseases | | | | |
| Uterine fibroids | 200 | 3-6 | months | Life Wave B 2 Hz |
| constipate | 80 | 3 | months | Life Wave B 5 Hz |
| Male and female | 90 | 3-6 | months | Life Wave B 2 Hz |
| reproductive | | | | |
| issues | | | | |
| cancer | 60 | 1 | year | Life Wave C 2 Hz |
| Heart disease | 130 | 6 | months | Life Wave C 5 Hz |
| Coronary heart | 30 | 9 | months | Life Wave C 5 Hz |
| disease | | | | |
| Myocardial | 70 | 3 | months | Life Wave C 3 Hz |
| infarction | | | | |
| Chest tightness | 80 | 1 | month | Life Wave C 3 Hz |
| and shortness of | | | | |
| breath | | | | |
| Palpitations | 90 | 3 | months | Life Wave C 2 Hz |
| Cerebral | 100 | 3 | months | Life Wave C 6 Hz |
| infarction | | | | |
| Stroke | 100 | 3-6 | months | Life Wave C 3 Hz |
| Cardiovascular | 120 | 9 | months | Life Wave C 5 Hz |
| and | | | | |
| cerebrovascular | | | | |
| diseases | | | | |

The “Life Wave Smart Acupuncture” device consists of a hardware sound wave generator and a software life wave. The sound wave generator is a device that can play ultra-low frequency sound (sound) waves of 18 Hz-3000 Hz. The device is a revolutionary invention from function to material and structure.

The principle of the smart acupuncture device is to restore the original early days of Chinese acupuncture, when there were no needles, and the “qi” energy was used. That is, the energy of “qi” when the old Chinese medicine practitioners are now moving the needles. (Acupuncturests who can't move the “qi” are modern acupuncturests)

The energy of “qi” can promote the meridians and drive blood circulation. “qi” is a wave, and sound waves are non-material and also belong to the category of music therapy. Through resonance, it solves the current medical problem of “microcirculation disorder”.

Why can smart acupuncture equipment solve various difficult and complicated diseases and chronic diseases? Because microcirculation disorder is the source of all diseases, smart acupuncture equipment can effectively and quickly solve the world's difficult problem of microcirculation disorder. In a word: microcirculation is the exchange place of nutrients and metabolic products. Therefore, whether the microcirculation function is normal or not is an important criterion for measuring the health status of the human body. Meridians and microcirculation; meridian blockage and microcirculation disorder are the “source of all diseases”, so what is the relationship between the two? Meridians: It is the pathway for running qi and blood, nourishing internal organs and limbs, and is the energy source for the body's life activities. Microcirculation: All the energy needed for human metabolism comes from blood, and the organs that transport blood, exchange substances, and nourish internal organs and tissues are only the microcirculation system. Then the meridians and microcirculation systems have something in common in structure and function, while the meridians exist objectively and the microcirculation exists subjectively, so there is the “microcirculation theory of the essence of meridians”. In other words, the meridians are the microcirculation system of the human body. If there is a microcirculation disorder in the brain, there will be insufficient blood supply to the brain and cerebral infarction. If there is a microcirculation disorder in the heart, there will be coronary heart disease, myocardial infarction, chest tightness and shortness of breath, palpitations, and severe sudden death. If the peripheral blood vessels have microcirculation disorders, varicose veins, vasculitis, leg pain, and leg swelling will occur. Blood vessels are blocked—it is called microcirculation disorder. Blockage in the heart—it is called myocardial infarction. Blockage in the head—it is called cerebral infarction. Blockage in the capillaries—it is called tumor. Blockage in the liver—it is called tumor. Blockage in the uterus—it is called fibroids. Blockage in the breast—it is called hyperplasia. Blockage in the thyroid—it is called nodule. Blockage in the face—it is called acne. Blockage in the skin—it is called pimple. Blockage in the legs—it is called varicose veins. Blockage in the mucous membrane—it is called cyst. Blockage in the neck—it is called cervical spondylosis. Especially when people are in a sleeping state, the blood flow rate is slower, and some patients with cardiovascular and cerebrovascular diseases are prone to accidents. This is the reason. Life Wave A, using one device (with four built-in sound wave sounders). It has the function of preventing and treating high blood pressure and various pains. Life Wave B, using two devices (with eight built-in sound wave sounders). It can prevent and treat diabetes, prostate, breast disease, gynecological diseases, constipation, male and female reproductive problems. Life Wave C, using bed equipment (built-in thirty sound wave sound generators). It can prevent and treat cancer, stroke, cardiovascular and cerebrovascular diseases, femoral head necrosis, herpes zoster, and microcirculation disorders.

Life Wave A, using one device (built-in four sound wave sound generators). It can prevent and treat hypertension, various pains, cervical spondylosis, lumbar spondylosis, and various bone and joint diseases.

Life Wave B, using two devices (built-in eight sound wave sound generators). It can prevent and treat diabetes, prostate, breast disease, varicose veins, thyroid nodules, gynecological diseases, uterine fibroids, constipation, male and female reproductive problems.

Life Wave C, using bed equipment (built-in thirty sound wave sound generators). It can prevent and treat cancer, heart disease, coronary heart disease, myocardial infarction, chest tightness and shortness of breath, palpitations, cerebral infarction, stroke, cardiovascular and cerebrovascular diseases, femoral head necrosis, herpes zoster, microcirculation disorders, etc.

Data 1. Software; Life Wave (A, B, C) Original data.

2. Hardware; Sound wave generator, a device that can play ultra-low frequency sound (sound) waves 18 Hz-3000 Hz. This device is a revolutionary invention from the function to the material and structure based on the principle of normal music speakers.

3. Pictures of one, two, bed, and space capsule.

4. Life Wave A, using one sound wave generator. Prevent and treat high blood pressure and various pains. Life Wave B, using two sound wave generators. Prevent and treat diabetes, prostate, breast disease, gynecological diseases, constipation, male and female reproductive problems.

Life Wave C, using ten sound wave generators. Prevent and treat cancer, stroke, cardiovascular and cerebrovascular diseases, femoral head necrosis, herpes zoster, and microcirculatory disorders.
Life wave A, copyright case number 1-13563734271
Life wave B, copyright case number 1-13564472558
Life wave C, copyright case number 1-13564553374

Example 1: Life Wave A, use one device (with four built-in sound wave generators). It can prevent and treat high blood pressure, various pains, cervical spondylosis, lumbar spondylosis, and various bone and joint diseases.

For high blood pressure: Place one device horizontally on the ground every morning, positioning the feet on the sound wave generator for one hour. Then, position the device vertically on a chair and sit on it, ensuring that the tailbone faces the sound wave generator behind (maintaining an upright posture provides the best effect) for one hour. At night, place the device horizontally at the foot position before sleeping, setting it for one to three hours. The device will stop automatically after sleep occurs.

After using it for ten days, the body will have different adjustment phenomena, and blood pressure will begin to drop. After using it for one month, the blood pressure will drop to normal values.

After using it for six months, the blood pressure will reach normal values.

Example 2: Life Wave A, use one device (with four built-in sound wave generators). It can prevent and treat high blood pressure, various pains, cervical spondylosis, lumbar spondylosis, and various bone and joint diseases.

For various pains, bone, and joint diseases: Position the feet on the sound wave generator on the device for one hour, then place the device upright on a chair and sit on it. Ensure the tailbone faces the sound wave generator behind, as maintaining an upright posture provides the best effect, for one hour to relieve various pains. Place or secure the device to the painful area for another hour, allowing pains to subside to varying degrees. The duration of use may vary depending on the type of pain and individual conditions. With continued use over different days, pain can be alleviated or eliminated.

Example 3: Life Wave B, use two devices (with eight built-in sound wave generators). It can prevent and treat diabetes, prostate, breast disease, varicose veins, thyroid nodules, gynecological diseases, uterine fibroids, constipation, male and female reproductive problems.

Usage instructions: Place one device horizontally on the ground every morning and position the feet on the sound wave generator for one hour. Then, position a second device vertically on a chair and sit on it, ensuring the tailbone faces the sound wave generator behind, as sitting upright provides the best effect, for one hour. At night, place one device horizontally at the foot position and set it for one to three hours; the device will stop automatically after sleep. The second device can be placed on the abdomen, with usage time and intensity adjustable according to individual preferences to promote natural sleep.

The body will have different adjustment phenomena after ten days of use. The symptoms will be relieved after more than thirty days of use. The recovery rate will reach 70% after six months of use. The recovery rate will reach 80% after one year of use. The recovery rate will reach 96% after two years of use.

Example 4: Life Wave C, using bed equipment (built-in thirty sound wave generators). It can prevent and treat cancer, heart disease, coronary heart disease, myocardial infarction, chest tightness and shortness of breath, palpitations, cerebral infarction, stroke, cardiovascular and cerebrovascular diseases, femoral head necrosis, herpes zoster, microcirculation disorders, etc.

How to use: Use it for one to three hours every morning and three hours at night.

After one month of use, various symptoms will be relieved. After one year of use, the recovery rate will reach 50%. After two years of use, the recovery rate will reach 70%. After three years of use, the recovery rate will reach 90%.

### REFERENCE

1. Dr. George Patrick of the National Institutes of Health discovered that the vibrational frequency of sound can relieve and heal patients' pain and symptoms while also lowering stress, exhaustion, pain, headaches, and nausea.
2. In his 1973 work “The Auditory Rhythm of the Brain.” Dr. Gerald Oster, a biophysicist and MD, noted that sound influences how the brain processes new information, regulates emotions, regulates sleep patterns, and responds. Other related research results also support the notion that the neurotransmitter serotonin can be generated by specific sound and musical frequencies. A 2009 study by the University of Jyvaskyla in Finland indicated that using low-frequency sound waves for treatment can aid the metabolism of bones as well as the body's blood circulation.
3. The Oncology Department of the Freiburg Medical School in Germany conducted a study on sound therapy in collaboration with the German Music Therapy Research Center in Heidelberg and discovered that there are some “specific sound frequencies” that can inhibit the growth of cancer cells and aid in the treatment of cancer patients.
4. Life wave A, copyright case number 1-13563734271, copyright application No. SR 992-588, Filed 2024 Feb. 28, registered Mar. 29, 2024.
5. Life wave B, copyright case number 1-13564472558, copyright application No. SR 992-632, Filed 2024 Feb. 28, registered Mar. 29, 2024.
6. Life wave C, copyright case number 1-13564553374, copyright application No. SR 992-585, Filed 2024 Feb. 28, registered Mar. 29, 2024.
7. Patent DEVICE FOR ACUPUNCTURE AND MOXIBUSTION THERAPY AND USES THEREOF, U.S. Ser. No. 17/616,723, filed Dec. 6, 2021, pending.
8. Patent DEVICE FOR ACUPUNCTURE AND MOXIBUSTION THERAPY AND USES THEREOF, U.S. Ser. No. 17/005,074, filed Aug. 27, 2020, issued Feb. 23, 2021.
9. Patent DEVICE FOR ACUPUNCTURE AND MOXIBUSTION THERAPY AND USES THEREOF, U.S. Ser. No. 17/179,559, filed Feb. 19, 2021, issued Oct. 17, 2023.
10. Patent DEVICE FOR ACUPUNCTURE AND MOXIBUSTION THERAPY AND USES THEREOF, U.S. Ser. No. 18/380,094, filed Oct. 13, 2023, pending.
11. Patent DEVICE FOR ACUPUNCTURE AND MOXIBUSTION THERAPY AND USES THEREOF, U.S. Ser. No. 18/022,829, filed Feb. 23, 2023, pending.
12. Design Patent DEVICE TO ENHANCE OR MAINTAIN HEALTH, U.S. Ser. No. 29/738,351, filed Jun. 17, 2020, now U.S. Pat. No. D948,735, issued Apr. 12, 2022.
13. Patent LIFE WAVES FOR THERAPY AND USES THEREOF, U.S. Ser. No. 18/884,800, filed Sep. 13, 2024, which is a continuation application of U.S. Ser. No. 18/593,399, filed Mar. 1, 2024, claiming priority of U.S. Ser. No. 63/449,502, filed Mar. 2, 2023.
14. Patent LIFE WAVES AND USES THEREOF, Application No. 63/560,482, filed Mar. 1, 2024, pending.
15. Patent— [symbol] , Chinese Application No. 202010222365.4, Filed Mar. 26, 2020, claiming priority of U.S. Ser. No. 62/858,072, Filed Jun. 6, 2019, pending.
16. Webpage: https://www.taiyi-institute.com/

1. A method for moderating physiological bodily conditions of a subject comprising
administering an appropriate amount of appropriate wave for an appropriate duration to the said subject thereby modulating the physiological conditions of the said subject.

2. The method in claim 1 wherein the wave is low frequency waves.

3. The method in claim 2 wherein the wave is less than 20 Hz.

4. The method in claim 1 wherein the conditions are cervical spondylosis, lumbar spondylosis, various bone and joint diseases, diabetes, prostate, breast disease, varicose veins, thyroid nodules, gynecological diseases, uterine fibroids, constipation, male and female reproductive problems, cancer, heart disease, coronary heart disease, myocardial infarction, chest tightness and shortness of breath, palpitations, cerebral infarction, stroke, cardiovascular and cerebrovascular diseases, femoral head necrosis, herpes zoster, microcirculation disorders, etc.

5. A device for moderating function in a subject capable of generating or transmitting appropriate life wave to moderate said function in said subject.

6. The device in claim 5 further comprising
a. a pad;
b. at least one wave-generating module or speaker system, embedded in the pad configured to emit said wave; and
c. a control unit, including a remote control or a wired connection configured to adjust the intensity and duration of the said wave.

7. The device in claim 5 further comprising
a. a bed;
b. at least one wave-generating module or speaker system, embedded in the bed, configured to emit the said wave; and
c. a control unit, including a remote control or a wired connection configured to adjust the intensity and duration of the said wave.

8. The device in claim 5 further comprising
a. a mattress;
b. at least one wave-generating module or speaker system, embedded in the mattress, configured to emit the said wave; and
c. a control unit, including a remote control or a wired connection configured to adjust the intensity and duration of the said wave.

9. The device in claim 5 further comprising
a. a pillow;
b. at least one wave-generating module or speaker system, embedded in the pillow, configured to emit the said wave; and
c. a control unit, including a remote control or a wired connection configured to adjust the intensity and duration of the said wave.

10. The device in claim 5 further comprising
a. a headset;
b. at least one wave-generating module or speaker system, embedded in the headset, configured to emit the said wave; and
c. a control unit, including a remote control or a wired connection configured to adjust the intensity and duration of the said wave.

11. The device in claim 5 further comprising
a. a helmet;
b. at least one wave-generating module or speaker system, embedded in the helmet, configured to emit the said wave; and
c. a control unit, including a remote control or a wired connection configured to adjust the intensity and duration of the said wave.

12. The device in claim 5 further comprising
a. a housing such that said subject can wear on the body;
b. at least one wave-generating module or speaker system, enclosed in the housing, configured to emit the said wave; and
c. a control unit, including a remote control or a wired connection configured to adjust the intensity and duration of the said wave.

13. The device in claim 12 wherein such housing is an acupuncture or moxibustion therapy device.

14. The device in claim 12 wherein such housing is a sphere allowing the said subject to wear around the pelvic area.

15. The device in claim 5 wherein the device is a speaker or amplifier configured to wear on the body of the said subject.

16. The device in claim 5 wherein the device is a speaker or amplifier configured to be mounted on a supporting element.

17. The device in claim 5 whereby further comprising
a. a capsule configured to enclose the said subject;
b. at least one wave-generating module or speaker system, embedded in the said capsule, configured to emit the said wave; and
c. a control unit, including a remote control, or a control board, or a control panel, or a wired connection or other control configured to adjust the intensity and duration of the said wave.

18. A method for moderating functions in a subject using life waves comprising steps of
a. selecting a wave of appropriate wavelength;
b. selecting an appropriate amplitude; and
c. choosing optimal duration so that the chosen life wave can affect and then moderate the said function.
